(19) United States
(12) Patent Application Publication
(10) Pub. No.: US 2026/0058853 A1
(43) Pub. Date: Feb. 26, 2026

(54) Time Domain Orthogonal Cover Codes for Uplink Sounding Reference Signal

(71) Applicant: Telefonaktiebolaget LM Ericsson (publ), Stockholm (SE)

(72) Inventors: Andreas Nilsson, Göteborg (SE); Shiwei Gao, Nepean (CA); Siva Muruganathan, Stittsville (CA); Sven Jacobsson, Västra Frölunda (SE)

(21) Appl. No.: 19/103,149

(22) PCT Filed: Aug. 11, 2023
(86) PCT No.: PCT/IB2023/058150

§ 371 Date: Feb. 11, 2025

Related U.S. Application Data
(60) Provisional application No. 63/397,637, filed on Aug. 12, 2022.

(51) Int. Cl. H04L 27/26

(52) U.S. Cl. CPC H04L 27/261; H04L 27/26412

(57) ABSTRACT

Sounding Reference Signal (SRS) capacity is increased by introducing Time Domain Orthogonal Cover Codes (TD-OCC) over multiple SRS repetitions. A UE may indicate to the network a capability to support TD-OCC for SRS. In response, the network provides configurations controlling the content and format of the SRS. An SRS resource configuration may include at least an SRS Repetition Factor≥2. A TD-OCC configuration may include at least one of a TD-OCC length and a TD-OCC code. The UE C indication may indicate a maximum TD-OCC length that is supported for an SRS resource; all TD-OCC lengths that are supported; that supported TD-OCC lengths are 2ⁿ for positive integers n; that different TD-OCC codes are supported for different SRS ports of an SRS resource; or that the TD-OCC length maybe different than the SRS Repetition Factor. Techniques are disclosed herein for implementing all of these variations.

### RELATED APPLICATIONS

This application claims the benefit of U.S. Provisional Application No. 63/397,637, filed 12 Aug. 2022, the disclosure of which is hereby incorporated by reference herein, in its entirety.

### TECHNICAL FIELD

The present disclosure relates generally to wireless communications, and in particular to the use of Time Domain Orthogonal Cover Codes (TD-OCC) for uplink sounding reference signals (SRS).

### BACKGROUND

Wireless communication signals are altered by the channel (air interface) across which they are transmitted. To assess the channel, reference signals (RS) have long been a part of wireless communications protocols. Various types of RS are defined, and are used in different situations. Because the channel is dynamic, RS are periodically transmitted in both Downlink (DL) and Uplink (UL) directions.

Sounding Reference Signals (SRS) are one type of RS transmitted by the UE in the UL direction. SRS are used by the base station (e.g., eNB in LTE; gNB in NR) to estimate the uplink channel quality over a wide bandwidth, and for uplink frequency selective scheduling. The eNB/gNB may also use SRS for uplink timing estimation, e.g., as part of a timing alignment procedure.

SRS are expected to become more and more vital for future communication systems. There are several reasons for this:
Time Division Duplex (TDD) operation is becoming more common.
Multiple Transmission/Reception Points (Multi-TRP) and distributed Multiple Input-Multiple Output (D-MIMO) operation are expected to become more common in 5G advance and 6G, and obtaining Channel State Information (CSI) from each TRP access point (AP) using DL reference signals will be overhead heavy.
Multiple User MIMO (MU-MIMO) is becoming more and more common, which requires rich channel knowledge at the network to perform null forming towards co-scheduled UEs. Attaining rich channel estimations using feedback-based CSI is very costly in terms of uplink feedback overhead.

There is a constant ongoing effort to enhance the SRS specification in NR and this is likely to continue for the coming releases. It is also likely that 6G may re-use many of the useful parts specified in NR's later releases as a starting point.

One problem with current SRS specification in NR is the limited SRS capacity, which limits the number of UEs that can transmit SRS resource simultaneously. One SRS feature in NR that can be used to enhance the SRS capacity is to apply frequency hopping. However, there are currently issues for UEs to maintain the phase coherency between different frequency hops. Furthermore, frequency hopping shortens the SRS sequence length in each hop, which makes SRS more sensitive towards (inter-cell) interference. Hence, frequency hopping may not always be suitable to use in commercial systems.

The Background section of this document is provided to place aspects of the present disclosure in technological and operational context, to assist those of skill in the art in understanding their scope and utility. Approaches described in the Background section could be pursued, but are not necessarily approaches that have been previously conceived or pursued. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of aspects of the disclosure or to delineate the scope of the disclosure. The sole purpose of this summary is to present some concepts disclosed herein in a simplified form as a prelude to the more detailed description that is presented later.

One way to increase SRS capacity is to introduce Time Domain Orthogonal Cover Code (TD-OCC) over multiple SRS repetitions. A UE may indicate to the network a capability to support TD-OCC for SRS. In response, the network provides configurations controlling the content and format of the SRS. An SRS resource configuration may include at least an SRS Repetition Factor≥2. A TD-OCC configuration may include at least one of a TD-OCC length and a TD-OCC code. The UE indication may indicate a maximum TD-OCC length that is supported for an SRS resource; all TD-OCC lengths that are supported; that supported TD-OCC lengths are 2ⁿ for positive integers n; that different TD-OCC codes are supported for different SRS ports of an SRS resource; or that the TD-OCC length maybe different than the SRS Repetition Factor. Techniques are disclosed herein for implementing all of these variations.

One aspect relates to a method of transmitting uplink SRS performed by a wireless device operative in a wireless communication network. A configuration of an SRS resource is received from the network. The SRS resource configuration includes at least an SRS Repetition Factor of the SRS resource. The SRS Repetition Factor, indicating a number of SRS repetitions in time domain, is two or greater. A configuration of TD-OCC for the SRS resource is received from the network. The TD-OCC configuration includes at least one of a TD-OCC length and a TD-OCC code. SRS are transmitted using the TD-OCC configuration applied over the SRS Repetitions.

Another aspect relates to a wireless device operative in a wireless communication network. The wireless device includes communication circuitry configured to communicate with one or more network nodes, and processing circuitry operatively connected to the communication circuitry. The processing circuitry is configured to perform the wireless device method described above.

Yet another aspect relates to a method, performed by a base station operative in a wireless communication network, of configuring a wireless device to transmit uplink SRS. A configuration of an SRS resource is transmitted to the wireless device. The SRS resource configuration includes at least an SRS Repetition Factor of the SRS resource. The SRS Repetition Factor, indicating a number of SRS repetitions in time domain, is two or greater. A configuration of TD-OCC for the SRS resource is transmitted to the wireless device. The TD-OCC configuration includes at least one of a TD-OCC length and a TD-OCC code. SRS using the TD-OCC configuration applied over the SRS Repetitions are received from the wireless device.

Still another aspect relates to a base station operative in a wireless communication network. The base station includes communication circuitry configured to communicate with one or more network nodes, and processing circuitry operatively connected to the communication circuitry. The processing circuitry is configured to perform the base station method described above.

### BRIEF DESCRIPTION OF THE DRAWINGS

The present disclosure will now be described more fully hereinafter with reference to the accompanying drawings, in which aspects of the disclosure are shown. However, this disclosure should not be construed as limited to the aspects set forth herein. Rather, these aspects are provided so that this disclosure will be thorough and complete, and will fully convey the scope of the disclosure to those skilled in the art. Like numbers refer to like elements throughout.

FIG. 1 is a PRB diagram showing wideband and narrowband SRS.

FIG. 2 is a PRB diagram showing one possible set of frequency locations for SRS transmission.

FIG. 3 are diagrams showing SRS transmission on different antenna ports at different times.

FIG. 4 is a diagram showing the transmission of different layers of a PDSCH from different Transmission/Reception Points (TRP).

FIG. 5 is a diagram showing coherent joint transmission (CJT) of the same layer of PDSCH from multiple TRPs.

FIG. 6 is a pseudo-code listing illustrating one example of how a new RRC field is introduced per SRS resource used to explicitly indicate that TD-OCC should be applied for that SRS resource.

FIG. 7 shows two timing diagrams illustrating that an SRS resource with repetition factor 4 has been configured with TD-OCC index 1 and 2 respectively.

FIG. 8 shows two timing diagrams illustrating that an SRS repetition factor is set to 5 but where TD-OCC codes of length 5 is not supported for the UE.

FIG. 9 is a pseudo-code listing illustrating one example of how two new RRC fields are introduced per SRS resource used to explicitly indicate that TD-OCC should be applied for that SRS resource.

FIG. 10 is a timing diagram illustrating repeating a TD-OCC code N′=2 times, where the repetition factor (8) is divided by the TD-OCC length (4).

FIG. 11 is a timing diagram illustrating the use of frequency hopping in transmitting the TD-OCC code of FIG. 12.

FIG. 12 is a timing diagram illustrating the use of frequency hopping in transmitting TD-OCC according to first and second TD-OCC indices.

FIG. 13 shows timing diagrams illustrating different length-6 TD-OCC codes applied over different OFDM symbols in which SRS is transmitted.

FIG. 14 shows timing diagrams illustrating different length-6 orthogonal TD-OCC codes repeated twice when the SRS resource is configured with repetition factor=12.

FIG. 15A shows 2 SRS repetitions with length-2 TD-OCC codes.

FIG. 15B shows 4 SRS repetitions with length 4 TD-OCC codes.

FIG. 16 is a flow diagram of a method of transmitting SRS.

FIG. 17 is a flow diagram of a method of configuring a wireless device to transmit SRS.

FIG. 18 is a block diagram of a communication system.

FIG. 19 is a block diagram of a UE.

FIG. 20 is a block diagram of a network node.

FIG. 21 is a block diagram of a host device.

FIG. 22 is a block diagram of a virtualization environment.

FIG. 23 is a block diagram of a host communicating via a network node with a UE over a partially wireless network connection.

### DETAILED DESCRIPTION

For simplicity and illustrative purposes, the present disclosure is described by referring mainly to an exemplary aspect thereof. In the following description, numerous specific details are set forth in order to provide a thorough understanding of the present disclosure. However, it will be readily apparent to one of ordinary skill in the art that the present disclosure may be practiced without limitation to these specific details. In this description, well known methods and structures have not been described in detail so as not to unnecessarily obscure the present disclosure.

### Frame Structure and Physical Channels

In the time domain, NR DL and UL transmissions are organized into equally sized subframes of 1 ms each. A subframe is further divided into multiple slots of equal duration. The slot length depends on subcarrier spacing. For 15 kHz subcarrier spacing, there is only one slot per subframe. In general, for 15·2^{μ} kHz subcarrier spacing, where μ∈{0,1,2,3,4}, there are 2^{μ} slots per subframe. Finally, each slot consists of 14 symbols (unless extended cyclic prefix is configured).

In the frequency domain, a system bandwidth is divided into Resource Blocks (RB) each corresponding to 12 contiguous subcarriers. One subcarrier during one symbol interval forms one Resource Element (RE).

Downlink transmissions are dynamically scheduled by the network, i.e., in each subframe the gNB transmits Downlink Control Information (DCI) about which UEs to which data is to be transmitted, and on which resource blocks in the current downlink subframe the data is transmitted. This control signaling is typically transmitted in the first one or two OFDM symbols in each subframe in NR. The control information is carried on Physical Control Channel (PDCCH) and data is carried on Physical Downlink Shared Channel (PDSCH). A UE first detects and decodes PDCCH and if a PDCCH is decoded successfully, it then decodes the corresponding PDSCH based on the decoded control information in the PDCCH.

UL data transmissions are also dynamically scheduled by the network using PDCCH. Similar to DL, a UE first decodes uplink grants in PDCCH and then transmits data over the Physical Uplink Shared Channel (PUSCH) based on the decoded control information in the uplink grant such as modulation order, coding rate, uplink resource allocation, etc.

In addition to PUSCH, Physical Uplink Control Channel (PUCCH) is also supported in NR to carry uplink control information (UCI) such as HARQ (Hybrid Automatic Repeat Request) related Acknowledgement (ACK), Negative Acknowledgement (NACK), or Channel State Information (CSI) feedback.

### Downlink Transmission Based on Channel Reciprocity

SRS are typically used for uplink channel measurements for the purpose of UL scheduling and link adaption, in which an SRS is sent by a UE and the UL channel is measured by the gNB to determine the UL CSI. In TDD systems, the DL and UL channels are reciprocal and thus, SRS can also be used to obtain DL CSI, at least DL PMI. Compared to CSI-RS based DL CSI feedback, this saves CSI feedback overhead and also potentially feedback latency.

### Sounding Reference Signals

SRS is supported in NR for uplink channel sounding. Similar to LTE, configurable SRS bandwidth is supported in NR. SRS can be configurable with regard to density in frequency domain (e.g., comb levels) and/or in time domain (including multi-symbol SRS transmissions).

A UE can be configured with one or more SRS resource sets, each SRS resource set can contain one or more SRS resources. Each SRS resource can contain

$${N}_{ap}^{SRS} ∈$$

{1,2,4}SRS antenna ports in a time-frequency resource with

$${N}_{symb}^{SRS} ∈$$

{1,2,4,8,10,12,14}consecutive OFDM symbols in a slot starting from OFDM symbol l₀ and a number of PRBs starting from subcarrier k₀.

### SRS Bandwidth

In general, two kinds of sounding bandwidths are supported, one is wideband, and the other is narrowband. In the case of wideband, channel measurement over a large system bandwidth can be performed in a single OFDM symbol. While in narrowband sounding, only part of the full bandwidth can be measured in each OFDM symbol, thus multiple SRS OFDM symbols are needed for a full bandwidth channel measurement. Frequency hopping is supported for narrowband SRS so that different parts of the full bandwidth can be measured in different SRS OFDM symbols.

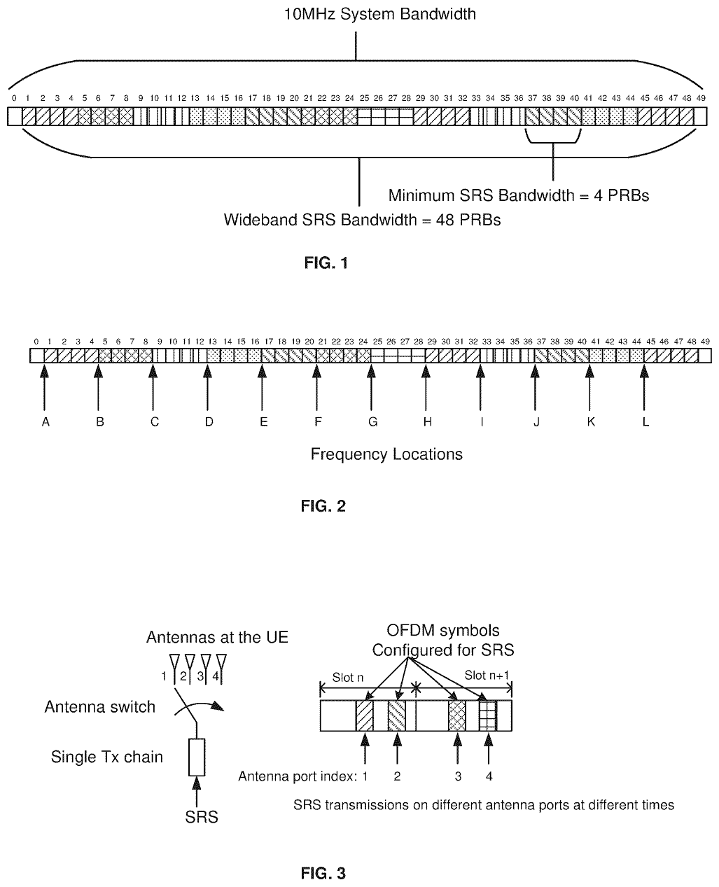

The SRS bandwidth for a UE is configurable and is in multiples of 4 PRBs. The minimum SRS bandwidth is 4 PRBs, which is also referred to as SRS subband. An example is shown in FIG. 1, depicting both wideband and narrowband SRS with a 10 MHz system bandwidth and 15 kHz subcarrier spacing.

In the case of narrowband SRS with frequency hopping (FH), an SRS is transmitted on different part of the system bandwidth at different SRS OFDM symbols. For example, for a 10 MHz system, with 15 kHz subcarriers spacing, and SRS bandwidth of 4 PRBs, a possible set of locations in the frequency domain for SRS transmission are shown in FIG. 2. In this example, the whole bandwidth can be measured after 12 SRS OFDM symbols.

Different UEs can be multiplexed on the same time-frequency resources by assigning different cyclic shifts. In addition, an SRS signal is only transmitted on a subset of the subcarriers in the configured SRS bandwidth (i.e., every K_“TC” subcarriers), configurable through a parameter called comb, thereby increasing the SRS multiplexing capacity provided that the channel is sufficiently flat so that channel measurement every K_“TC” subcarriers is adequate and so that ports assigned to different cyclic shifts are not interfering with each other.

### SRS Resource Types

An SRS resource can be periodic, semi-persistent, or aperiodic. In case of periodic or semi-persistent SRS, a UE transmits SRS periodically at certain configured SRS slots. In case of aperiodic SRS, a UE transmits SRS only when it is requested by gNB.

Joint DL Transmission from Multiple TRPs

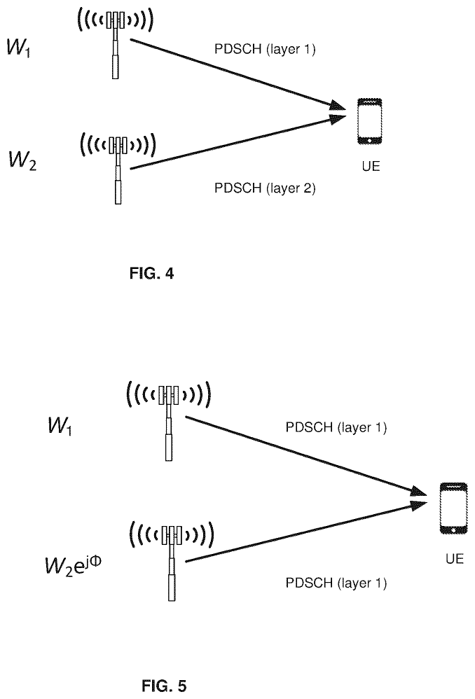

Non-coherent joint DL PDSCH transmission (NC-JT) is supported in NR Rel-16 in which a subset of layers of a PDSCH can be transmitted from a first Transmission/Reception Point (TRP) and the rest of layers of the PDSCH can be transmitted from a second TRP. An example is shown in FIG. 4, where layer 1 of a PDSCH is transmitted from TRP1 while layer 2 of the PDSCH is transmitted from TRP2. When multiple antenna ports are deployed at each TRP, a precoding matrix would be applied to the PDSCH at each TRP, e.g., w_1 at TRP1 and w_2 at TRP2. The two TRPs may be in different physical locations.

In NR Rel-18, coherent joint PDSCH transmission (CJT) from multiple TRPs is to be introduced in which a PDSCH layer can be transmitted from up to four TRPs. An example is shown in FIG. 5, where the same PDSCH layer is transmitted over two TRPs. When multiple antenna ports are deployed at each TRP, a precoding matrix would be applied to the PDSCH at each TRP. In addition, a co-phasing factor is also applied so that the PDSCH from the two TRPs are phase-synchronized and thus can be coherently combined at the UE.

### Use and Configurations of TD-OCC

In order to mitigate the problem of limited capacity of SRS, new ways of using/applying TD-OCC are provided.

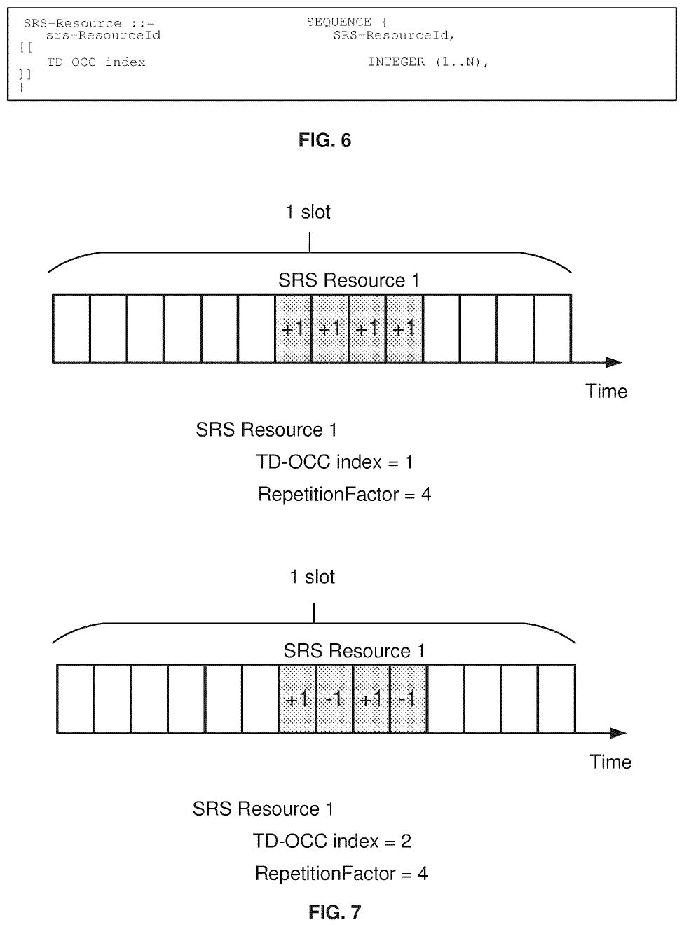

FIG. 6 illustrates one example of how a new RRC field is introduced per SRS resource (i.e., per SRS-resource as specified in TS 38.331) for indicating the configuration of TD-OCC (e.g. step 104). Notably, the new RRC field can be used to explicitly indicate that the TD-OCC should be applied for that SRS resource. For example, the new RRC field indicates the TD-OCC code index that should be applied over the R repetitions of the SRS resources.

FIG. 7 illustrates two examples where an SRS resource with repetition factor 4 has been configured with TD-OCC index 1 and 2, respectively. In this example, Hadamard code is applied as TD-OCC code. However, cyclic shifts of, e.g., a Zadoff-Chu sequence, or DFT codes may be used as well. In one aspect of the disclosure, if a repetition factor of R is configured together with a TD-OCC code index for an SRS resource, a TD-OCC of length R will be applied over the R consecutive/repeated symbols of that SRS resource.

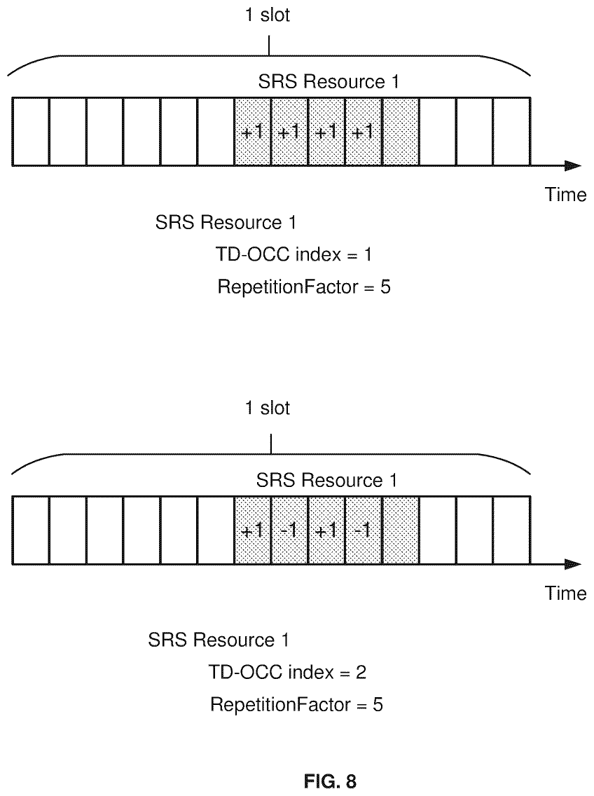

FIG. 8 illustrates two other examples, where the SRS repetition factor is set to 5, but where TD-OCC codes of length 5 are not supported for the UE. In this case, the UE applies the TD-OCC code over the X first symbols of the SRS resource, where X is the closest number of supported TD-OCC lengths smaller than the configured repetition factor. For the example in FIG. 10, a TD-OCC length of 4 is the closest supported TD-OCC length (from, e.g., set {2, 4, 8}) that is smaller than the configured repetition factor 5. The UE still transmits the 5th repetition, but without applying any TD-OCC code on it (e.g., it uses weight+1 irrespectively of which TD-OCC index that has been configured).

In another example, when the supported TD-OCC length and configured SRS repetition factor differ for an SRS resource, the UE can disregard the TD-OCC configuration when transmitting that SRS resource (i.e., transmit legacy SRS repetition).

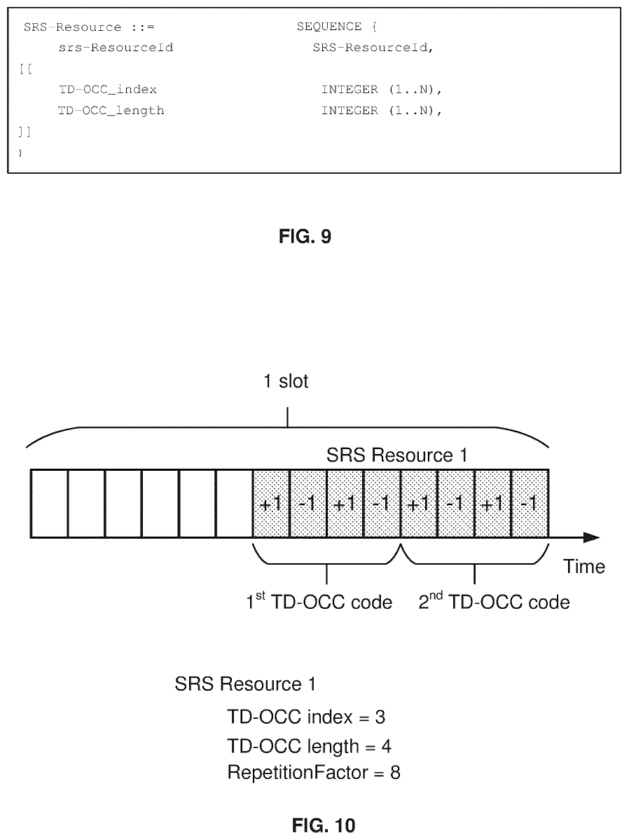

FIG. 9 illustrates one example of how two new RRC fields are introduced per SRS resource (i.e., per SRS resource as specified in TS 38.331) used to explicitly indicate that TD-OCC should be applied for that SRS resource. The two new RRC field indicates the TD-OCC code index and the TD-OCC code length that should be applied over the R repetitions of the SRS resources.

In one example, the UE is not expected to be configured with a combination of TD-OCC length (X) and repetition factor (R) that results in a non-integer when the repetition factor (R) is divided by the TD-OCC length (X) (i.e., the UE is not expected to be configured with a repetition factor R and a TD-OCC length X where R/X is not an integer number).

In one example, when the repetition factor (R) divided by the TD-OCC length (X) for an SRS resource is an integer N′ where N′ is larger than 1, the TD-OCC code is repeated N′ times over the SRS resource repetitions. One example of this aspect of the disclosure is illustrated in FIG. 10, where N′ is equal to two, so the 8 symbols/repetitions for the SRS resource are divided into two TD-OCC codes, each with length 4.

In legacy SRS configuration, it is possible to configure both a repetition factor R and a number of SRS symbol per slot M (N_“symb”\hat{ }“SRS” in TS 38.211), for which it must hold that M≥R and M/R is an integer.

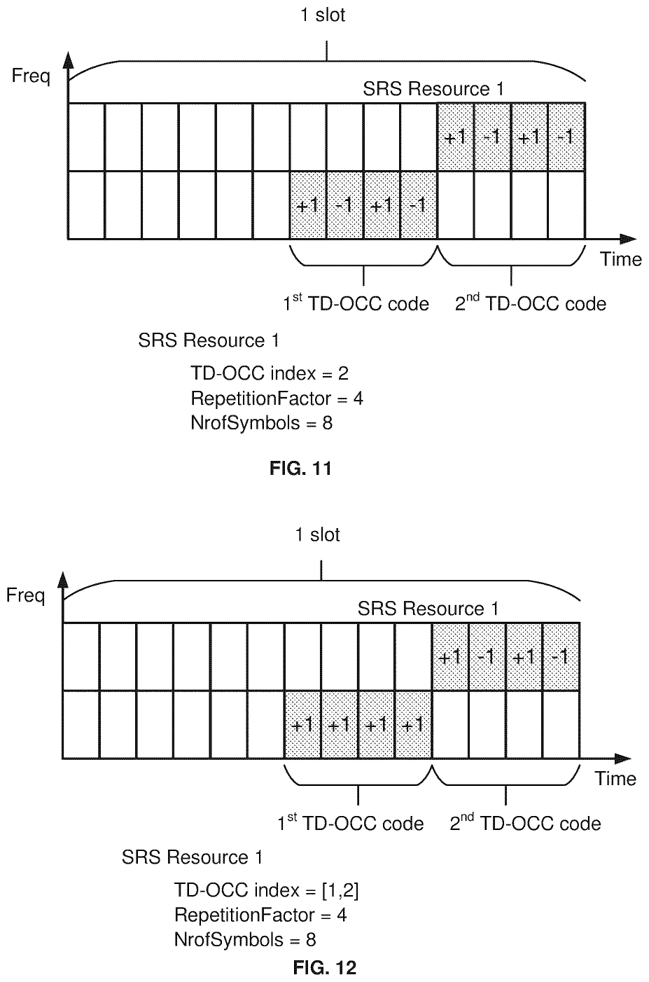

In one aspect of the disclosure, if M>R, the TD-OCC length is implicitly determined by (and equal to) the repetition factor (i.e., TD-OCC code is equal to R) and the TD-OCC code (which is determined by a preconfigured TD-OCC index, as in the above) spans each set of R consecutive/repeated SRS symbols. Note that, if frequency hopping is configured, the different sets of R consecutive/repeated SRS symbols may be transmitted in different parts of the configured bandwidth. An example of this is provided in FIG. 11.

In one aspect of the disclosure, it is possible to RRC configure M/R TD-OCC indices for an SRS resource, where a first TD-OCC index is used to determine the TD-OCC in a first set of R SRS symbols, a second TD-OCC index is used to determine the TD-OCC in a second set of R SRS symbols and so on. An example of this is provided in FIG. 12. The benefit of this approach is that interference may be randomized when said SRS resource is co-scheduled with other SRS resources.

In another aspect of the disclosure, if M>R, a length-M codeword c_{M} is formed as follows:

$${c}_{M} = vec ( {c}_{R} ⊗ {1}_{M / R} )$$

Here, c_{R} is the length-R TD-OCC (determined by the TD-OCC index), 1_{M/R} is the all-one vector of length M/R, ⊗ denotes the Kronecker product, and vec(⋅) is the vectorization function (which converts a matrix to a column vector). For example, if c_{R}=[+1, −1, +1, −1]^{T} then c_{R}=[+1, +1−1, −1+1,+1, −1, −1]^{T}. In this aspect of the disclosure, it is preferred that frequency hopping is not configured.

In one aspect of the disclosure, an SRS resource configured with multiple SRS ports and where the SRS resource is configured for TD-OCC, different TD-OCC codes are applied to the different SRS ports. One benefit with this solution is that the orthogonality between the different SRS ports will be less sensitive to delay spread in the channel (currently the SRS ports of the same SRS resource are separated with cyclic shifts in the frequency dimension, which when the delay spread in the channel is large, will result in cross SRS port interference). By applying different TD-OCC codes in addition to different cyclic shifts in frequency dimension, the gNB can separate the SRS ports belonging to the same SRS resource using the TD-OCC code instead of the cyclic shifts, when the delay spread in the channel is large.

Alternatively, two SRS ports may share the same cyclic shift but be configured with different TD-OCC codes. In one aspect of the disclosure, if TD-OCC is configured for a multi-port SRS resource, all SRS ports are configured to use the same cyclic shift (which, e.g., is RRC configured through the legacy parameter cyclicShift).

In one alternative aspect of the disclosure, if both repetition factor and TD-OCC code are configured, the TD-OCC length is used as the SRS repetition factor (i.e., TD-OCC length overrides configured SRS repetition factor).

In one aspect of the disclosure, the TD-OCC codes of different lengths are specified in 3GPP specifications (e.g., different tables may be specified for each TD-OCC code length; each table consists of the different TD-OCC codes corresponding to each TD-OCC code length). Which length of TD-OCC to apply is chosen by the UE based on the indicated number of SRS repetition factor or number of SRS symbols configured.

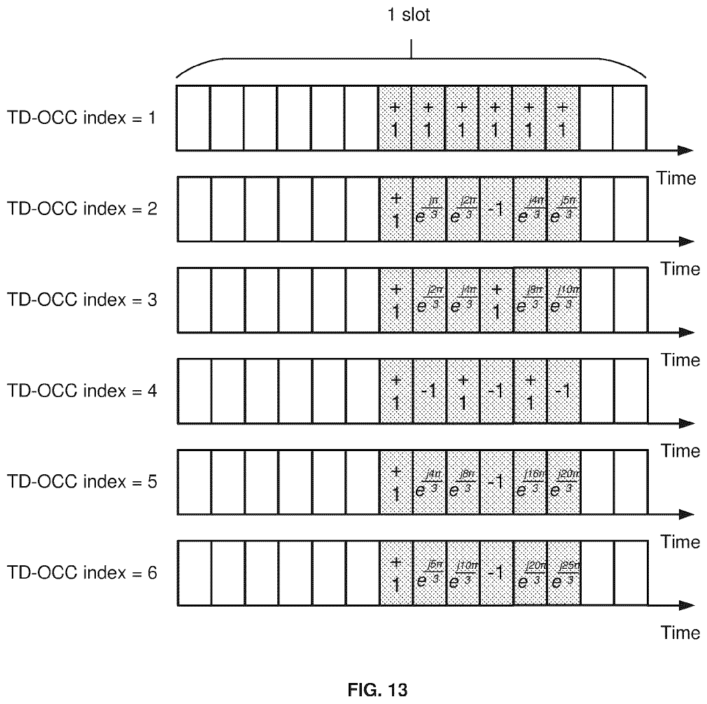

In another aspect of the disclosure, length-6 orthogonal TD-OCC code is applied over time (i.e., over OFDM symbols) for SRS resource(s) with repetition factor 6. FIG. 13 shows an example of different length-6 TD-OCC codes applied over different OFDM symbols in which SRS is transmitted. In some aspects of the disclosure, the different TD-OCC codes given by the different TD-OCC indices shown in the figure may be used by different UEs transmitting different SRSs with repetition factor 6. In another aspect of the disclosure, up to 2 of the different TD-OCC codes shown in the figure may be used to transmit an SRS with 2 ports by the same UE over 6 OFDM symbols. In yet another aspect of the disclosure, up to 4 of the different TD-OCC codes shown in the figure may be used to transmit an SRS with 4 ports by the same UE over 6 OFDM symbols. The TD-OCC index of the TD-OCC code to be used may be configured as part of SRS resource configuration.

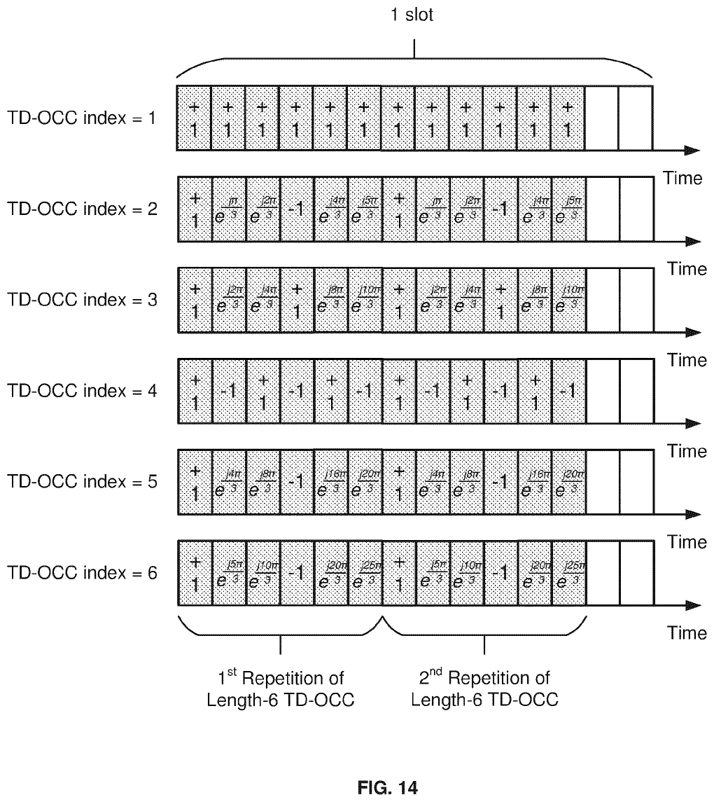

In another aspect of the disclosure, when the SRS resource is configured with repetition factor 12, a length-6 orthogonal TD-OCC code may be repeated twice in time domain as shown in FIG. 14. The TD-OCC index of the TD-OCC code to be repeated twice may be configured as part of SRS resource configuration.

In an alternative aspect of the disclosure, to further randomize interference, two different length-6 orthogonal TD-OCC codes may be used for the first repetition in the first 6 OFDM symbols and the second repetition in the second 6 OFDM symbols. The TD-OCC indices of the two different length-6 orthogonal TD-OCC codes to be repeated may be configured as part of SRS resource configuration.

In the above aspect of the disclosure, the TD-OCC indices, or a list of TD-OCC indices of the two or more TD-OCC codes to be used may be configured as part of SRS resource configuration.

In some alternative aspect of the disclosure, the TD-OCC index, or the list of TD-OCC indices to be used may be configured at SRS resource set level, or SRS configuration level in 3GPP TS 38.331 instead of being configured at the SRS resource level.

In a further aspect of the disclosure, the configured TD-OCC code for an SRS resource is the TD-OCC code for the lowest RB in the configured SRS bandwidth and all TD-OCC codes are cycled through the SRS bandwidth. An example is shown in FIG. 17, where the SRS resource is configured with TD-OCC code #0 and the SRS has a bandwidth of 8 RBs.

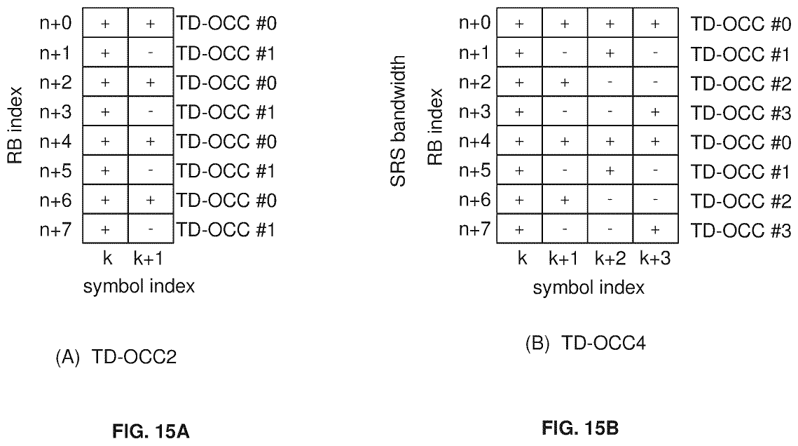

FIG. 15(a) shows 2 SRS repetitions with length 2 TD-OCC codes and FIG. 15(b) shows 4 SRS repetitions with length 4 TD-OCC codes. It can be seen that all TD-OCC codes for a given length are applied cyclically in different RBs. This would randomize SRS interference in the configured SRS resource.

### Methods, Apparatuses, Computer Code

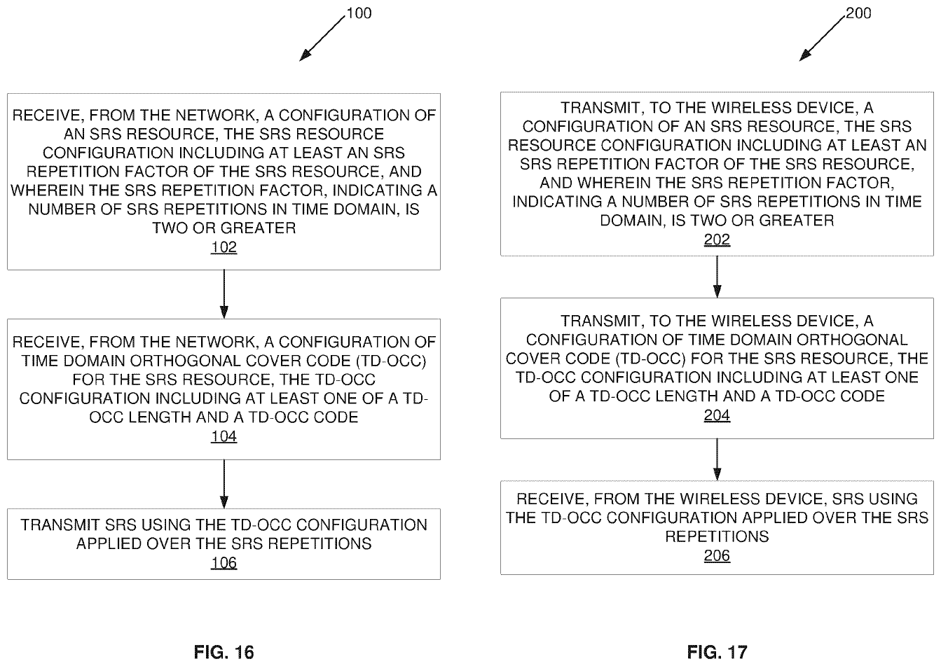

For example, FIG. 16 depicts a method 100 in accordance with particular aspects of the disclosure. The method 100 is performed by a wireless device operative in a wireless communication network, for transmitting UL SSRS. A configuration of an SRS resource is received from the network (block 102). The SRS resource configuration includes at least an SRS Repetition Factor of the SRS resource. The SRS Repetition Factor, indicating a number of SRS repetitions in time domain, is two or greater. A configuration of TD-OCC for the SRS resource is received from the network (block 104). The TD-OCC configuration includes at least one of a TD-OCC length and a TD-OCC code. SRS are transmitted using the TD-OCC configuration applied over the SRS Repetitions (block 106).

FIG. 17 depicts a method 200 in accordance with other particular aspects of the disclosure. The method 200 is performed by a base station operative in a wireless communication network. The method 200 is one of configuring a wireless device to transmit UL SRS. A configuration of an SRS resource is transmitted to the wireless device (block 202). The SRS resource configuration includes at least an SRS Repetition Factor of the SRS resource. The SRS Repetition Factor, indicating a number of SRS repetitions in time domain, is two or greater. A configuration of TD-OCC for the SRS resource is transmitted to the wireless device (block 204). The TD-OCC configuration includes at least one of a TD-OCC length and a TD-OCC code. SRS using the TD-OCC configuration applied over the SRS Repetitions are received from the wireless device (block 206).

Apparatuses described herein may perform the methods 100, 200 herein and any other processing by implementing any functional means, modules, units, or circuitry. In one aspects of the disclosure, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several aspects of the disclosure. In aspects of the disclosure that employ memory, the memory stores program code that, when executed by the one or more processors, carries out the techniques described herein. Apparatuses and wireless communication networks in which they operate are described in greater detail herein below.

Those skilled in the art will also appreciate that aspects of the disclosure herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Aspects of the disclosure further include a carrier containing such a computer program. This carrier may comprise one of an electronic signal, optical signal, radio signal, or computer readable storage medium.

In this regard, aspects of the disclosure herein also include a computer program product stored on a non-transitory computer readable (storage or recording) medium and comprising instructions that, when executed by a processor of an apparatus, cause the apparatus to perform as described above.

Aspects of the disclosure further include a computer program product comprising program code portions for performing the steps of any of the aspects of the disclosure herein when the computer program product is executed by a computing device. This computer program product may be stored on a computer readable recording medium.

### Network Description and Over the Top (OTT) Embodiments

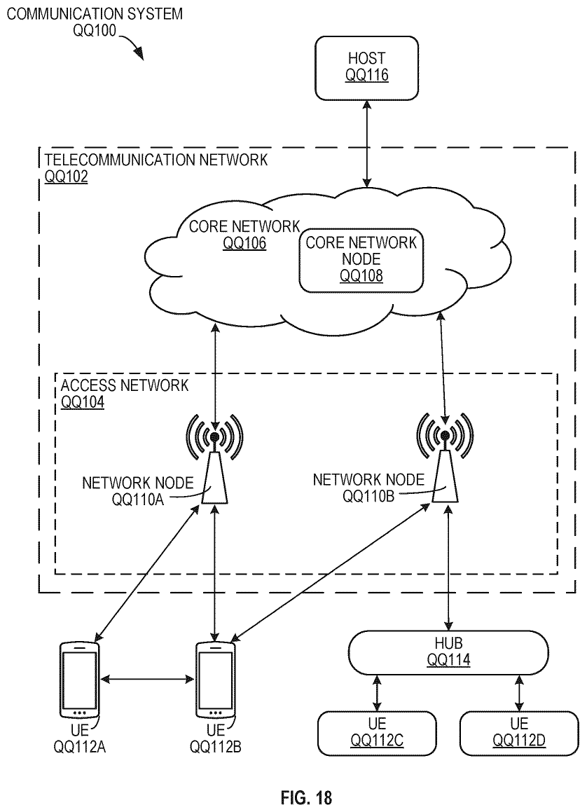

FIG. 18 shows an example of a communication system QQ100 in accordance with some aspects of the disclosure.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different aspects of the disclosure, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 18 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some aspects of the disclosure, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular if one or more of the UEs are low-energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some aspects of the disclosure, the hub QQ114 may be a dedicated hub—that is, a hub whose primary function is to route communications to/from the UEs from/to the network node QQ110b. In other aspects of the disclosure, the hub QQ114 may be a non-dedicated hub—that is, a device which is capable of operating to route communications between the UEs and network node QQ110b, but which is additionally capable of operating as a communication start and/or end point for certain data channels.

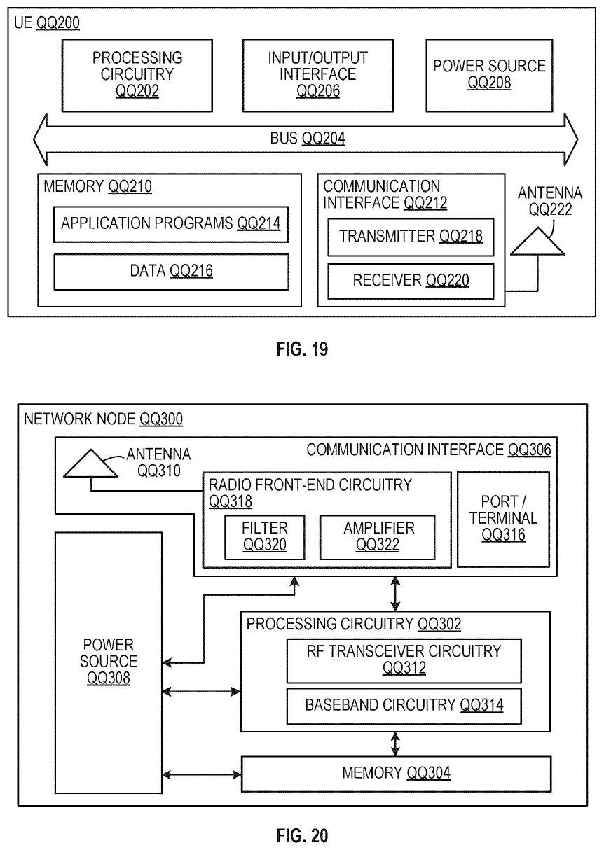

FIG. 19 shows a UE QQ200 in accordance with some aspects of the disclosure. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 19. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some aspects of the disclosure, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable ROM (PROM), erasable PROM (EPROM), electrically EPROM (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated aspect of the disclosure, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected, an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, an industrial robot, an Unmanned Aerial Vehicle (UAV), and any kind of medical device, like a heart rate monitor or a remote controlled surgical robot, etc. A UE in the form of an IoT device comprises circuitry and/or software in dependence of the intended application of the IoT device in addition to other components as described in relation to the UE QQ200 shown in FIG. 19.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 20 shows a network node QQ300 in accordance with some aspects of the disclosure. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some aspects of the disclosure, the network node QQ300 may be configured to support multiple radio access technologies (RATs). In such aspects of the disclosure, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some aspects of the disclosure, the processing circuitry QQ302 includes a system on a chip (SOC). In some aspects of the disclosure, the processing circuitry QQ302 includes one or more of radio frequency (RF) transceiver circuitry QQ312 and baseband processing circuitry QQ314. In some aspects of the disclosure, the radio frequency (RF) transceiver circuitry QQ312 and the baseband processing circuitry QQ314 may be on separate chips (or sets of chips), boards, or units, such as radio units and digital units. In alternative aspects of the disclosure, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some aspects of the disclosure, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain aspects of the disclosure a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other aspects of the disclosure, the communication interface may comprise different components and/or different combinations of components.

In certain alternative aspects of the disclosure, the network node QQ300 does not include separate radio front-end circuitry QQ318, instead, the processing circuitry QQ302 includes radio front-end circuitry and is connected to the antenna QQ310. Similarly, in some aspects of the disclosure, all or some of the RF transceiver circuitry QQ312 is part of the communication interface QQ306. In still other aspects of the disclosure, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain aspects of the disclosure, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Aspect of the disclosures of the network node QQ300 may include additional components beyond those shown in FIG. 20 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

FIG. 21 is a block diagram of a host QQ400, which may be an aspect of the disclosure of the host QQ116 of FIG. 18, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other aspects of the disclosure. Features of these components may be substantially similar to those described with respect to the devices of previous figures, such as Figures QQ2 and QQ3, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Aspect of the disclosures of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

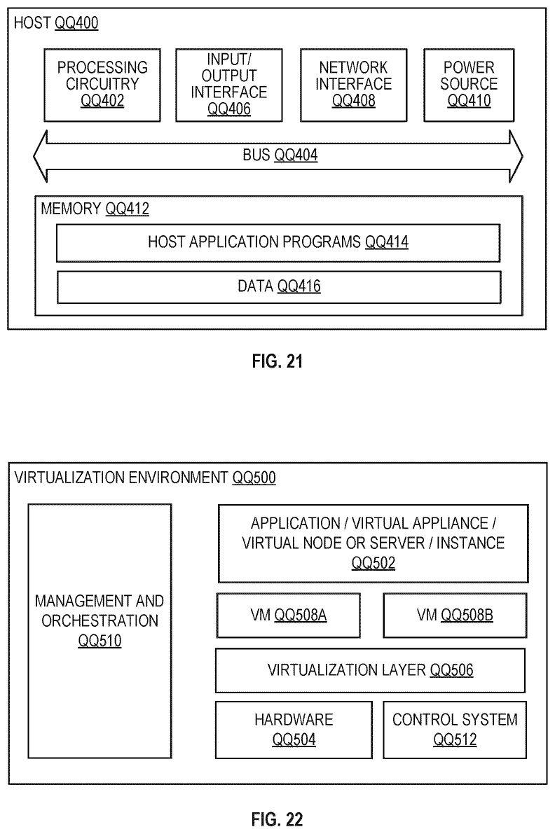

FIG. 22 is a block diagram illustrating a virtualization environment QQ500 in which functions implemented by some aspects of the disclosure may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in aspects of the disclosure in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the aspects of the disclosure disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some aspects of the disclosure described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different aspects of the disclosure of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g., such as in a data center or CPE) where many hardware nodes work together and are managed via management and orchestration QQ510, which, among others, oversees lifecycle management of applications QQ502. In some aspects of the disclosure, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some aspects of the disclosure, some signaling can be provided with the use of a control system QQ512 which may alternatively be used for communication between hardware nodes and radio units.

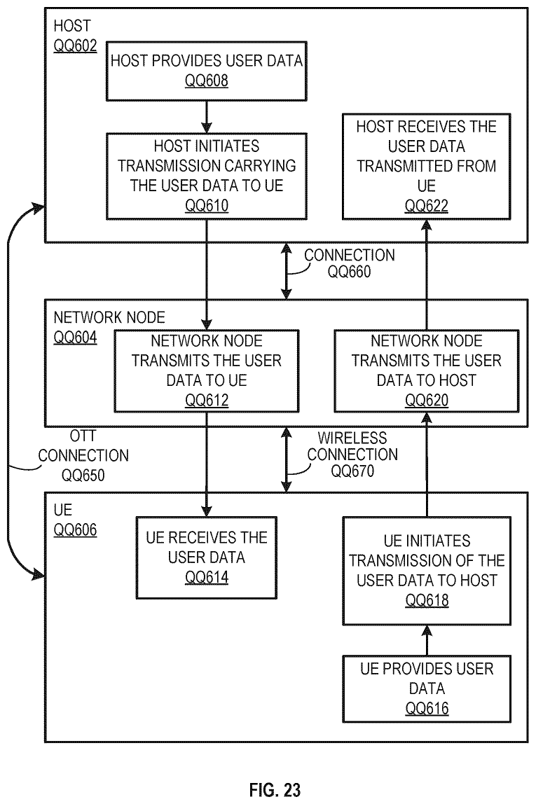

FIG. 23 shows a communication diagram of a host QQ602 communicating via a network node QQ604 with a UE QQ606 over a partially wireless connection in accordance with some aspects of the disclosure. Example implementations, in accordance with various aspects of the disclosure, of the UE (such as a UE QQ112a of FIG. 18 and/or UE QQ200 of FIG. 19), network node (such as network node QQ110a of FIG. 18 and/or network node QQ300 of FIG. 20), and host (such as host QQ116 of FIG. 18 and/or host QQ400 of FIG. 21) discussed in the preceding paragraphs will now be described with reference to FIG. 23.

Like host QQ400, aspects of the disclosure of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 18) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some aspects of the disclosure, the user data is associated with a particular human user interacting with the UE QQ606. In other aspects of the disclosure, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the aspects of the disclosure described throughout this disclosure. Accordingly, in step QQ612, the network node QQ604 transmits to the UE QQ606 the user data that was carried in the transmission that the host QQ602 initiated, in accordance with the teachings of the aspects of the disclosure described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the aspects of the disclosure described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various aspects of the disclosure improve the performance of OTT services provided to the UE QQ606 using the OTT connection QQ650, in which the wireless connection QQ670 forms the last segment. More precisely, the teachings of these aspects of the disclosure may improve the efficiency, data rate, and robustness and thereby provide benefits such as better responsiveness, increased Quality of Service, and reduced congestion.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more aspects of the disclosure improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some aspects of the disclosure, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain aspects of the disclosure, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other aspects of the disclosure may comprise computing devices with different combinations of components. It is to be understood that these computing devices may comprise any suitable combination of hardware and/or software needed to perform the tasks, features, functions, and methods disclosed herein. Determining, calculating, obtaining or similar operations described herein may be performed by processing circuitry, which may process information by, for example, converting the obtained information into other information, comparing the obtained information, or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain aspects of the disclosure, some or all of the functionality described herein may be provided by processing circuitry executing instructions stored on in memory, which in certain aspects of the disclosure may be a computer program product in the form of a non-transitory computer-readable storage medium. In alternative aspects of the disclosure, some or all of the functionality may be provided by the processing circuitry without executing instructions stored on a separate or discrete device-readable storage medium, such as in a hard-wired manner. In any of those particular aspects of the disclosure, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Advantages Over the Prior Art

Certain aspects of the disclosure may provide one or more of the following technical advantage(s), including increased UL SRS signal capacity compared to using SRS repetition. Compared to SRS frequency hopping, TD-OCC does not suffer from potential phase coherency issues between different frequency hops, and does not shorten the sequence length, which will facilitate the channel estimations based on the SRS.

SRS is becoming more and more important, and there are already bottlenecks in commercial systems due to poor SRS capacity. Hence, improving the SRS capacity will increase the overall performance in the communication systems, both for 5G and 6G. For SRS, by introducing a TD-OCC, SRS repetition factor can be increased without increasing the overhead signaling.

### OTT Embodiments

### Group A Embodiments

The Group A embodiments include claims 1-24.
100. The method of any of the Group A embodiments, further comprising:
   providing user data; and
   forwarding the user data to a host via the transmission to the network node.

### Group B Embodiments

The Group B embodiments include claims 26-49.
102. The method of any of the Group B embodiments, further comprising: obtaining user data; and
   forwarding the user data to a host or a user equipment.

### Group C Embodiments

103. A user equipment for transmitting uplink (UL) reference signals (RS), comprising:
   processing circuitry configured to perform any of the steps of any of the Group A embodiments; and
   power supply circuitry configured to supply power to the processing circuitry.
104. A network node for receiving uplink (UL) reference signals (RS), the network node comprising:
   processing circuitry configured to perform any of the steps of any of the Group B embodiments;
   power supply circuitry configured to supply power to the processing circuitry.
105. A user equipment (UE) for transmitting uplink (UL) reference signals (RS), the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
106. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to receive the user data from the host.
107. The host of the previous embodiment, wherein the cellular network further includes a network node configured to communicate with the UE to transmit the user data to the UE from the host.
108. The host of the previous 2 embodiments, wherein:
   the processing circuitry of the host is configured to execute a host application, thereby providing the user data; and
   the host application is configured to interact with a client application executing on the UE, the client application being associated with the host application.
109. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs any of the operations of any of the Group A embodiments to receive the user data from the host.
110. The method of the previous embodiment, further comprising:
   at the host, executing a host application associated with a client application executing on the UE to receive the user data from the UE.
111. The method of the previous embodiment, further comprising:
   at the host, transmitting input data to the client application executing on the UE, the input data being provided by executing the host application,
   wherein the user data is provided by the client application in response to the input data from the host application.
112. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to transmit the user data to the host.
113. The host of the previous embodiment, wherein the cellular network further includes a network node configured to communicate with the UE to transmit the user data from the UE to the host.
114. The host of the previous 2 embodiments, wherein:
   the processing circuitry of the host is configured to execute a host application, thereby providing the user data; and
   the host application is configured to interact with a client application executing on the UE, the client application being associated with the host application.
115. A method implemented by a host configured to operate in a communication system that further includes a network node and a user equipment (UE), the method comprising:
   at the host, receiving user data transmitted to the host via the network node by the UE, wherein the UE performs any of the steps of any of the Group A embodiments to transmit the user data to the host.
116. The method of the previous embodiment, further comprising:
   at the host, executing a host application associated with a client application executing on the UE to receive the user data from the UE.
117. The method of the previous embodiment, further comprising:
   at the host, transmitting input data to the client application executing on the UE, the input data being provided by executing the host application,
   wherein the user data is provided by the client application in response to the input data from the host application.
118. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
119. The host of the previous embodiment, wherein:
   the processing circuitry of the host is configured to execute a host application that provides the user data; and
   the UE comprises processing circuitry configured to execute a client application associated with the host application to receive the transmission of user data from the host.
120. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs any of the operations of any of the Group B embodiments to transmit the user data from the host to the UE.
121. The method of the previous embodiment, further comprising, at the network node, transmitting the user data provided by the host for the UE.
122. The method of any of the previous 2 embodiments, wherein the user data is provided at the host by executing a host application that interacts with a client application executing on the UE, the client application being associated with the host application.
123. A communication system configured to provide an over-the-top service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
124. The communication system of the previous embodiment, further comprising:
   the network node; and/or
   the user equipment.
125. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
126. The host of the previous 2 embodiments, wherein:
   the processing circuitry of the host is configured to execute a host application, thereby providing the user data; and
   the host application is configured to interact with a client application executing on the UE, the client application being associated with the host application.
127. The host of the any of the previous 2 embodiments, wherein the initiating receipt of the user data comprises requesting the user data.
128. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of the Group B embodiments to receive the user data from the UE for the host.
129. The method of the previous embodiment, further comprising at the network node, transmitting the received user data to the host.

1-46. (canceled)

47. A method of transmitting uplink Sounding Reference Signals (SRS) performed by a wireless device operative in a wireless communication network, the method comprising:
receiving, from the network, a configuration of an SRS resource, the SRS resource configuration including at least an SRS Repetition Factor of the SRS resource, and wherein the SRS Repetition Factor, indicating a number of SRS repetitions in time domain, is two or greater;
receiving, from the network, a configuration of Time Domain Orthogonal Cover Code (TD-OCC) for the SRS resource, the TD-OCC configuration including at least one of a TD-OCC length and a TD-OCC code index; and
transmitting SRS using the TD-OCC configuration applied over the SRS Repetitions.

48. The method of claim 47, further comprising, prior to receiving the SRS resource configuration or TD-OCC configuration:
transmitting, to the network, an indication of a capability to support TD-OCC for SRS.

49. The method of claim 48 wherein the indication of a capability to support TD-OCC for SRS further comprises an indication of a maximum TD-OCC length that is supported for SRS.

50. The method of claim 48 wherein the indication of a capability to support TD-OCC for SRS indicates support for applying different TD-OCC codes for different SRS ports of an SRS resource.

51. The method of claim 48 wherein the indication of a capability to support TD-OCC for SRS indicates support of using a TD-OCC length that is different than the SRS Repetition Factor.

52. The method of claim 47 wherein transmitting SRS using the TD-OCC configuration applied over the SRS Repetitions comprises transmitting SRS with one or more TD-OCC codes corresponding to the TD-OCC code index.

53. The method of claim 47 wherein a TD-OCC code is applied over all repetitions of an SRS or a subset of the SRS repetitions

54. The method of claim 47 wherein the TD-OCC configuration for the SRS does not apply to an SRS with an odd Repetition Factor or a Repetition Factor other than 2ⁿ, where n is a positive integer.

55. The method of claim 47 wherein an SRS is configured with a Repetition Factor that differs from a supported TD-OCC length, and wherein transmitting SRS using the TD-OCC configuration applied over the SRS Repetitions comprises transmitting SRS with the TD-OCC code applied over the first X repetitions of the SRS, where X is the largest number of supported TD-OCC codes smaller than the Repetition Factor.

56. The method of claim 55 wherein the Repetition Factor divided by the TD-OCC length for an SRS is an integer X wherein X>1, and wherein transmitting SRS using the TD-OCC configuration applied over the SRS Repetitions comprises transmitting the SRS repeating the TD-OCC X times over the SRS repetitions.

57. The method of claim 47 wherein different SRS ports of the same SRS resource are associated with different TD-OCC codes.

58. A wireless device operative in a wireless communication network, comprising:
communication circuitry configured to communicate with one or more network nodes; and
processing circuitry operatively connected to the communication circuitry and configured to:
receive, from the network, a configuration of an SRS resource, the SRS resource configuration including at least an SRS Repetition Factor of the SRS resource, and wherein the SRS Repetition Factor, indicating a number of SRS repetitions in time domain, is two or greater;
receive, from the network, a configuration of Time Domain Orthogonal Cover Code (TD-OCC) for the SRS resource, the TD-OCC configuration including at least one of a TD-OCC length and a TD-OCC code index; and
transmit SRS using the TD-OCC configuration applied over the SRS Repetitions.

59. A method, performed by a base station operative in a wireless communication network, of configuring a wireless device to transmit uplink Sounding Reference Signals (SRS) comprising:
transmitting, to the wireless device, a configuration of an SRS resource, the SRS resource configuration including at least an SRS Repetition Factor of the SRS resource, and wherein the SRS Repetition Factor, indicating a number of SRS repetitions in time domain, is two or greater;
transmitting, to the wireless device, a configuration of Time Domain Orthogonal Cover Code (TD-OCC) for the SRS resource, the TD-OCC configuration including at least one of a TD-OCC length and a TD-OCC code; and
receiving, from the wireless device, SRS using the TD-OCC configuration applied over the SRS Repetitions.

60. The method of claim 59, further comprising, prior to transmitting the SRS resource configuration or TD-OCC configuration:
receiving, from the wireless device, an indication of a capability to support TD-OCC for SRS.

61. The method of claim 60 wherein the indication of a capability to support TD-OCC for SRS indicates a maximum TD-OCC length that is supported for an SRS resource.

62. The method of claim 59 wherein receiving, from the wireless device, SRS using the TD-OCC configuration applied over the SRS Repetitions comprises receiving SRS with one or more TD-OCC codes corresponding to the TD-OCC code index.

63. The method of claim 62 wherein a TD-OCC code is applied over all repetitions of an SRS or a subset of the SRS repetitions.

64. The method of claim 63 wherein the TD-OCC configuration for the SRS does not apply to an SRS with an odd Repetition Factor or a Repetition Factor other than 2ⁿ, where n is a positive integer.

65. The method of claim 59 wherein the TD-OCC configuration for the SRS includes a first field indicating the TD-OCC code index, and a second field indicating the TD-OCC length.

66. The method of claim 59 wherein the TD-OCC code is one of a Hadamard code, a cyclic shift, and a Discrete Fourier Transform.
